(19) United States
(12) Patent Application Publication
(10) Pub. No.: US 2008/0225542 A1
(43) Pub. Date: Sep. 18, 2008

(54) LIGHT FOR VEHICLES, IN PARTICULAR FOR MOTOR VEHICLES

(75) Inventors: Jens Mertens, Esslingen (DE); Andreas Vlastnik, Ludwigsburg (DE); Rainer Bottesch, Stuttgart (DE); Gerhard Esser, Deizisau (DE)

Correspondence Address: REISING, ETHINGTON, BARNES, KISSELLE, P.C., P O BOX 4390, TROY, MI, 48099-4390, US

(73) Assignee: odelo GmbH, Schwaikheim (DE)

(21) Appl. No.: 12/046,848

(22) Filed: Mar. 12, 2008

(30) Foreign Application Priority Data
Mar. 12, 2007 (DE) 10 2007 012 256.1

(51) Int. Cl. F21V 7/00

(52) U.S. Cl. 362/517

(57) ABSTRACT

Lights, for example, in the form of rear lights, have luminous fields (11, 12, 15, 16, 17, 22) in the form of the flasher, the brake light, the tail light and the back-up light. In order to guarantee a homogeneous illumination that is as uniform as possible, the light has reflectors, of which a first reflector reflects the light, coming from a light source, to a luminous field (11, 12, 15, 16, 17, 22), respectively a pane (10). The side of this reflector that faces away from the pane (10) has the additional reflector, which reflects the light of an additional light source past the first reflector to the pane (10). The additional light enables a homogeneous illumination without the need for a lot of technical complexity. The light is intended, in particular, for motor vehicles.

The invention relates to a light for vehicles, in particular for motor vehicles, as claimed in the preamble of claim 1.

There exist lights, for example, in the form of rear lights, which exhibit luminous fields in the form of the flasher, the brake light, the tail light and the back-up light. Homogeneous illumination may be obtained only with difficulty and/or with considerable complexity.

The object of the invention is to construct a light, conforming to its genre, in such a manner that it guarantees a homogeneous illumination that is as uniform as possible, while simultaneously exhibiting a simple design as well as ease of manufacture and assembly.

This object is achieved with the light, which conforms to its genre and exhibits the characterizing features disclosed in claim 1.

In the case of the light according to the invention, the additional reflector with the additional light source provides that the reflected beams are guided past the reflectors and the light sources that are responsible for the luminous fields. This additional light makes possible a homogeneous illumination without the need for a lot of technical complexity.

Other features of the invention follow from the other claims, the description, and the drawings.

The invention is explained in detail below with reference to the embodiments, depicted in the drawings.

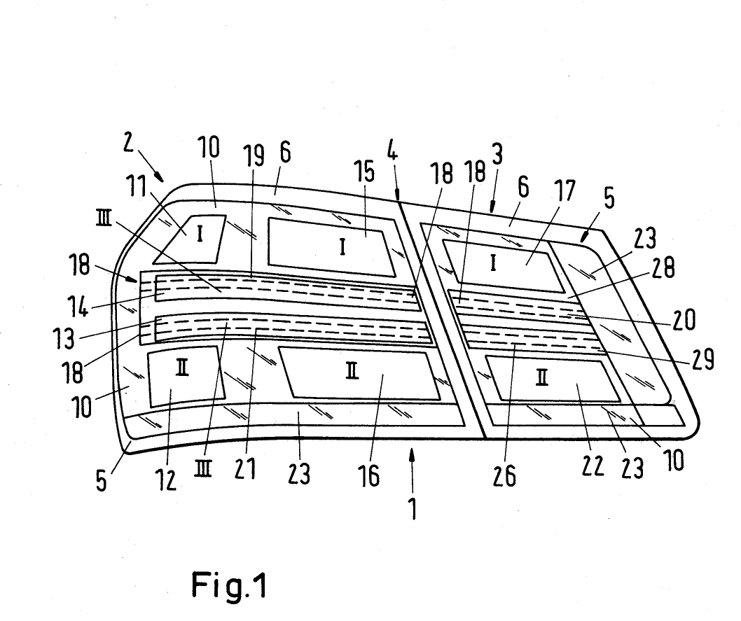

FIG. 1 is a view of an inventive light comprising an external and an internal light part.

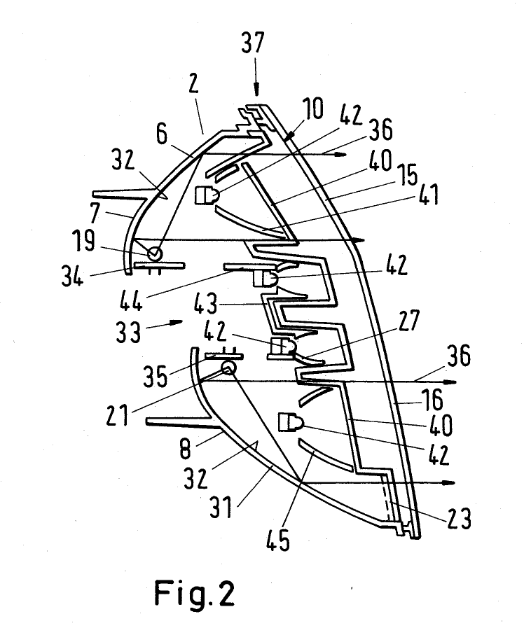

FIG. 2 is a schematic drawing of a cross sectional view of the external light part of the inventive light, according to FIG. 1.

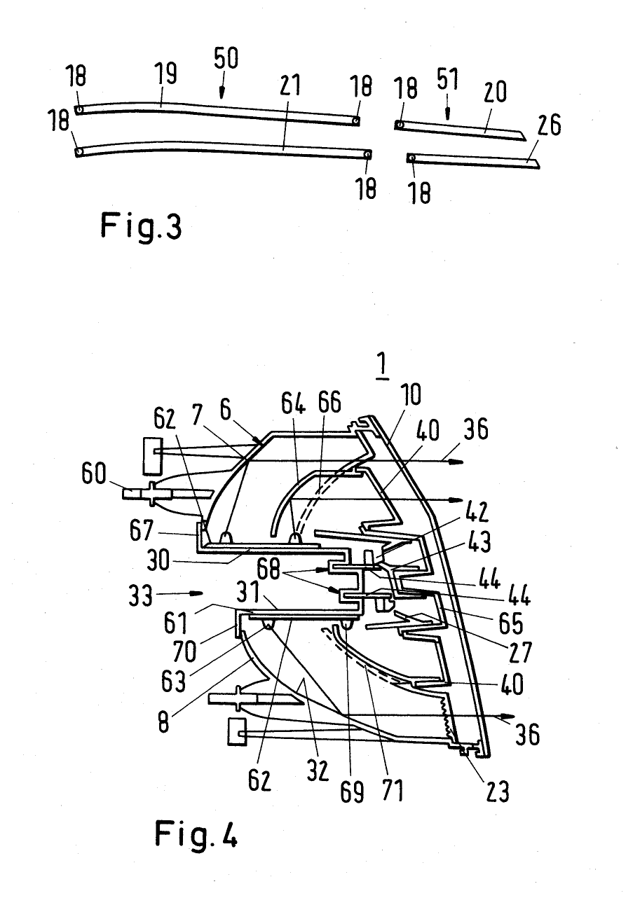

FIG. 3 depicts light strips of the inventive light, according to FIG. 1. Said light strips are formed by rod-shaped light guides.

FIG. 4 is a drawing, analogous to FIG. 2, of a second embodiment of the light, according to the invention.

The light 1 has an external light part 2 and an internal light part 3. If the light 1 is a rear light of a motor vehicle, then the external light part 2 is usually located in the rear-sided area of the mud guard of the motor vehicle, whereas the internal light part 3 is, for example, part of the trunk lid of the motor vehicle. If the trunk lid or even the hatchback door of a motor vehicle is closed, then there is a partition 4 between the two light parts 2, 3. This partition coincides with the separation between the mud guard and the trunk lid or the hatchback door. The divided light 1, which is illustrated here, is, of course, merely an example. The light may also be designed as a monolith.

The light 1 has a housing 6 for the external light part 2 and the internal light part 3. The internal light part 3 has, for example, a smaller visible surface than the external light part 2. Of course, both light parts may also exhibit visible surfaces that are the same size. Moreover, the external light part 2 may exhibit a smaller visible surface than the internal light part 3. The outer contours of the light parts 2, 3 are tailored to the application of the light 1. Diverging from the illustrated outer contour, which is approximately rectangular, the light parts 2, 3 may also have other outer contours.

Both light parts 2, 3 have a pane 10, which serves as the lighting background. The pane 10 of the external light part 2 fills almost the entire visible side of this light part. The pane 10 of the light part 3 is significantly smaller than the visible side of this light part. The pane 10 of the external light part 2 is surrounded by a rim 5 of the light housing 6. The width of this rim is approximately equal to that of said pane. The rim 5, surrounding the luminous field 10 of the internal light part 3, is wider in the area, facing away from the external light part 2, than in the rest of the rim region. Depending on the construction of the internal light part 3, the pane 10 may also be surrounded by a rim, the width of which is approximately equal to that of the pane. The pane 10 forms advantageously a homogeneously closed, illuminated surface, when the light source, located behind it, is switched on.

The pane 10 of the external light part 2 has six luminous fields 11, 12, 13, 14, 15, 16. The luminous fields 11, 15 and 12, 16 are disposed at a distance apart side by side and one above the other. The luminous fields 15, 16 exhibit a rectangular shape and extend in the longitudinal direction of the light part 2. The luminous field 11, which is disposed adjacent to the luminous field 15 at a distance apart, has a trapezoid contour, whereas the luminous field 12, which is situated adjacent to the luminous field 16, has a rectangular contour. Between the luminous fields 11, 15; 12, 16 there are the luminous fields 13, 14, which are arranged one above the other and which exhibit advantageously the same size. These luminous fields extend over approximately the entire width of the luminous fields, which are positioned at a distance apart above and below them. This configuration of the luminous fields is merely an example. Depending on the design of the light 1 and/or the intended application, the luminous fields may exhibit a variety of shapes.

The pane 10 of the internal light part 3 is provided with two luminous fields 17, 22, which are disposed one above the other and are advantageously the same size. These luminous fields exhibit a rectangular contour and are, for example, the same size as the luminous fields 15, 16 of the external light part 2. Between these luminous fields there are two additional luminous fields 28, 29, which are spaced apart and which are in alignment with the luminous fields 13, 14 and are wider than the luminous fields 17, 22. The fact that the luminous fields may exhibit a different contour also applies to the luminous fields 17, 22, 28, 29.

The area behind the luminous fields 13, 14 has two light guides 19, 21, which run parallel to each other. The light guides are disposed at a short distance from each other and extend over almost the entire length of these luminous fields 13, 24.

In the area behind the luminous fields 28, 29 of the internal light part 3 there are also two light guides 20, 26, which are disposed at a distance apart one above the other. They extend over the length of the luminous fields 28, 29 and are spaced a short distance apart from each other.

Behind the pane 10 there are, for example, retro-reflectors 23 in the area below the bottom luminous fields 12, 16 and 22. These retro-reflectors totally reflect the light coming in from the outside. Even the areas of the pane 10 that are not covered by the other luminous fields 11, 12, 15, 16, 17, 22, may be fitted with such retro-reflectors.

If the light 1 is a rear light, then the luminous fields have a variety of signal functions. For example, these luminous fields may be a brake light, a flasher, a reversing light or a rear fog light. In this case the configuration of these various lights is governed by the type of light and the statutory provisions. The luminous fields 11 to 17, 22, 28, 29 are illuminated by at least one light source. In order to illuminate the areas of the pane 10 that surround the luminous fields, the light guides 19, 21; 20, 26 are used. These light guides emit their light onto these areas indirectly by way of the reflectors. As FIG. 2 shows, these reflectors 41, 45 are located at the level of the luminous fields 15, 16 behind the pane 10 of the external light part 2. These reflectors are located behind an inner pane 40. The rim of the pane is attached—for example, adhesively cemented or welded—to the inside of the light housing 6. At the focal point of the reflectors 41, 45, there is at least one light source 42, which is advantageously an LED. The light, emitted by the light source, is reflected to the inner pane 40 by means of the reflectors 41, 45. From said inner pane the light travels to the outer pane 10, through which the light passes out of the light 1 to the outside. The inner pane 40 and/or the outer pane 10 may exhibit optical systems, with which the light may be guided in the desired manner.

The area of the central luminous fields 13, 14 has at least one reflector 43, 27, in the focal point of which there is at least one light source 42, preferably an LED. The reflector 27, 44 reflects the light radiated by the associated light source 42, through the inner pane 40 in the direction of the outer pane 10, through which the light passes out of the light 1 to the outside. In the area of the reflectors 27, 44 the cross section of the inner pane 40 is approximately U-shaped. The reflectors 27, 41, 43, 45 are set apart from each other. The two central reflectors 27, 43 have a smaller opening angle than the two outer reflectors 41 and 45, since their allocated sections of the inner pane 40 are smaller than the pane sections, assigned to the central reflectors 27, 43. The inner pane 40 is positioned opposite the outer pane 10 at a distance apart.

Inside the housing 6 the rod-shaped light guides 19, 21 are located at the level of the luminous fields 13, 14, on the side of the reflectors 27, 41, 43, 45 that faces away from the pane 10. These light guides extend from the edge of the luminous fields 13, 14 that is adjacent to the internal light part 3 as far as up to the

opposite edge of the luminous field 24. At the end of this luminous field, light is coupled into the rod-shaped light guides 19, 21 by means of a light source 18. The light source 18 is an LED, which sits on a printed circuit board 34, 35. The light feed into the light guides 19, 21 may also be coupled in by way of more than one light source 18, which is advantageously an LED. Even at the opposite end, light may be coupled into the light guides 19, 21 by means of at least one light source 18, which is advantageously an LED. The light may be coupled into the light guides 19, 21 by means of well-known methods, for example by applying the LED 18 to a coupling-in area at the end of the light guide.

The light guides 19, 21 supply the area, surrounding the luminous fields 11, 12, 13, 14, 15, 16, with background lighting. This is achieved by assigning each light guide 19, 21 a reflector 7, 8. This reflector is formed advantageously by means of one part of the inside of the light housing 2. These inside areas may be provided with a reflecting coating 32. The reflectors 7, 8 and the light guides 19, 21 are arranged in such a manner that the light, which is coupled out of the respective light guide, is reflected at the reflectors 7, 8 in the direction of the outer pane 10. The light beams 36, which run parallel to each other, also pass through the inner pane 40 in the area adjacent to the reflectors 27, 41, 43 and 45.

These reflectors 27, 31, 43, 45 may be designed so as to transmit light. Then the light, reflected at the reflectors 7, 8, also passes through these reflectors, so that the entire visible side of the light 1 is illuminated in a homogeneous manner. Not until the corresponding light source 42 is switched on are the individual luminous fields 11, 12, 13, 14, 15, 16 visible and are clearly recognized from the outside with respect to their respective signal function.

Even the retro-reflectors 23 in the bottom rim area of the light 1 may be designed so as to transmit light, so that in this area the

light, reflected at the reflectors 7, 8, passes to the outside. As FIG. 2 shows, the retro-reflectors 23 are provided advantageously on the inside of the inner pane 40. The retro-reflectors 23 may also exist on the inside of the outer pane 10.

The light guides 19, 21 are curved in conformity with the curvature of the light housing 2 or rather its wall and are mounted on the printed circuit boards 34, 35, which also conform with this curvature. The reflectors 7, 8 are formed in accordance with the required optical reflection geometry. Since the reflectors 7, 8 are formed advantageously by means of sections of the wall of the housing 6, the construction space and the weight of the light are decreased, and the number of parts to be mounted is minimized. The printed circuit boards 34, 35 lie at right angles, preferably orthogonally to the adjacent wall section of the housing 6.

In order to assemble, the backside of the light housing 6 is provided with an opening 33, which in the case of the mounted light is closed advantageously by means of a seal. Through this seal the supply lines for the components, to be supplied with current/voltage, may be run into the light 1. The light guides 19, 21 with the light sources 18 and the printed circuit boards 34, 35 are situated advantageously in the immediate vicinity of the opening 33, so that these parts may be easily assembled and, if necessary, also disassembled.

The internal light part 3 is designed in a manner analogous to the described external light part 2. Below the outer pane 10 there is the inner pane 40, the cross section of which is also stepped as in the case of the light part 2. The protruding parts, which are formed by the gradation and which belong to the inner pane 40, form the luminous fields 17, 28, 29, 22 of the internal light part 3. Each luminous field 17, 28, 29, 22 is assigned in turn at least one reflector, in the focal point of which is at least one light source, preferably an LED. At the level of the central luminous fields 28, 29 there are the two rod-shaped light guides 20, 26, which

are arranged in the region between the reflectors, assigned to the luminous fields 17, 28, 29 22, and the rear wall of the housing 2. The light guides 20, 26 are mounted in turn on the printed circuit boards, which run at right angles, advantageously orthogonally to the adjacent wall section of the housing 6. Light is coupled into the end of the light guides 20, 26 that faces the external light part 3 by means of at least one light source 18, preferably an LED. Like the light guides 19, 21, the light guides 20, 26 are also constructed in such a manner that they couple out the light in such a distributed manner over their length that the light impinges on the rear-sided reflectors, which are assigned to the housing 6 and where the light beams are reflected forwards in the direction of the pane 10. In so doing, the reflected beams also pass through the inner pane 40. As in the case of the light part 2, in the case of the light part 3 the reflectors, which are assigned to the luminous fields 17, 28, 29, 22, are designed so as to transmit light, so that the light, which is coupled out by the light guides 20, 26, also passes through the luminous field-sided reflectors by means of the corresponding reflectors.

FIG. 3 depicts the light guides 19, 21, 20, 36, each of which exhibits the shape of a rod. As a function of the width of the light parts 2, 3, the light guides 19, 21 are longer than the light guides 20, 26. From both ends the light source 18 couples the light into the light guides 19, 21, whereas in the case of the light guides 20, 26 the light source 18 couples light only into one end. The arrangement and curvature of the light guides 19, 21; 20, 26 is a function of the light geometry.

The light guides 19, 21 form a light strip 50; and the light guides 20, 26 form a light strip 51. With these two light strips 50, 51, the pane 10 of the two light parts 2, 3 is uniformly illuminated at least in the region outside the luminous fields. If the reflectors, assigned to the luminous fields, are light transmitting, then the entire visual surface of the light 1 is uniformly illuminated. The technical complexity for this feature is low, because only the light guides and at least one respective light source must be provided. The light guides can be easily manufactured and

assembled in the required shape. At the same time the light guides with the light sources demand very little space, so that even very flat lights may be constructed in the described manner.

In the embodiment according to FIG. 4, a light source carrier 61 is housed in the light 1. When the light source carrier 61 is used, it is advantageous for the rear sided opening 33 in the light housing 6 to extend over the width of the light. The light source carrier 61 has in essence a U-shaped cross section with legs 30, 31, which run parallel to each other. The free ends of the legs are bent at right angles in opposite directions to each other, in order to form the holding flanges 67, 70. In the assembled state the holding flanges 67, 70 restoptionally with the intercalation of a seal-against the rim of the opening 33.

The face side of the light source carrier 61 is formed in such a manner that two slotted receptacles 68 for the printed circuit boards 44 are formed. The receptacles 68 extend parallel to the legs 30, 31 of the light source carrier 61. The receptacles 68 hold securely the printed circuit boards 44. The length and width of the receptacles 68 are a function of the thickness and length of the printed circuit boards 44. They may be provided, for example, with plug connectors (not illustrated), which interact with the contact receptacles of the light source carrier 61. In this way it is possible for the printed circuit boards 44 and the light sources 42, which are advantageously LEDs and which are mounted on said printed circuit boards, to make contact easily. As FIG. 4 shows, the LEDs 42 are mounted in such a way on the printed circuit boards 44 that they emit their light parallel to the flat side of the printed circuit boards 44.

The large area printed circuit boards 62 are mounted on the outer sides (which face away from each other) of the legs 30, 31 of the light source carrier 61. The light sources 63, 69, which are advantageously LEDs, sit on the printed circuit boards. The light sources 63 are positioned adjacent to the holding flanges 67, 70 and interact with the housing-sided reflectors 7, 8. These reflectors reflect the light, emitted by the light sources 63, through the inner pane 40 and the outer pane 10, as explained above with reference to FIG. 2.

The light sources 69, which are disposed at a further distance from the holding flanges 67, 70, are assigned reflectors 64, 66, 71, with which the light, emitted by the light sources 69, is reflected to the respective luminous fields.

As in the case of the previous embodiment, the luminous fields are formed by corresponding profilings of the inner pane 40. Each of the two central luminous fields is assigned the respective reflector 27, 43, in the focal point of which is situated at least one light source 42. The light, which is emitted by said light source, is guided, as explained with reference to FIG. 2, to the related luminous field by way of the respective reflector 27, 43.

The reflectors 64, 66, 71 may be made of light transmitting material, so that in the region of these reflectors the light, reflected by the reflectors 7, 8, also passes to the inner pane 40 and from there to the outer pane 10.

The use of the light source carrier 61, which is essentially U-shaped in its cross section, makes it possible to easily fit the light 1 with a variety of light sources and to position easily and quickly relative to the reflectors. The individual parts of the light 1 can be easily mounted, for example, by snap locking or clipping. Moreover, the components of the light 1 may be adhesively cemented or welded together. At the light source carrier 61 the printed circuit boards 62 with the light sources 63, 69 as well as the printed circuit boards 44 with the light sources 42 may be preassembled. This preassembled module may be inserted through the opening 33 of the light housing 6 and mounted on the light housing. The large area attachment of the printed circuit boards 44, 62 to the light source carrier 61 is advantageous, since in this way the light sources 42, 63, 69 can be mounted in an accurate and simple way. As a result of the large area

contact between the printed circuit boards and the light source carrier 61, the heat dissipation is outstanding, so that the heat that is generated from running the light sources for a prolonged period of time can be reliably dissipated. It is also possible to house, for example, cooling devices, such as cooling elements, fans and the like, with which additional cooling can be achieved, in the space of the light source carrier 61, said space being enveloped by the legs 30, 31 and the face side.

Fastening elements 60, with which the light can be fastened to the vehicle by methods that are well known, project from the backside of the light housing 6.

Moreover, the light 1, according to FIG. 4, is constructed in the same way as the embodiment, according to FIGS. 1 to 3.

1. Light for vehicles, in particular for motor vehicles, comprising a light housing, which exhibits at least one luminous field, to which is assigned at least one reflector with at least one light source, and a pane, which closes the light housing,
characterized in that the side of the reflector (27, 41, 43, 45; 27, 43, 64, 66, 71) that faces away from the pane (10) has at least one additional reflector (7, 8), which reflects the light of at least one additional light source (18, 19, 20, 21, 26; 63) past the other reflector (27, 41, 43, 45; 27, 43, 64, 66, 71) to the pane (10).

2. Light, as claimed in claim 1,
characterized in that the additional light source (18, 19, 20, 21, 26) exhibits at least one light guide (19, 20, 21, 26).

3. Light, as claimed in claim 2,
characterized in that the light guide (19, 20, 21, 26) is adapted to the contour of the additional reflector (7, 8).

4. Light, as claimed in claim 3,
characterized in that the light guide (19, 20, 21, 26) sits on a printed circuit board (34, 35), which conforms at least approximately to the contour of the additional reflector (7, 8).

5. Light, as claimed in claim 1,
characterized in that the additional light source (63) is formed by a row of LEDs.

6. Light, as claimed in claim 5,
characterized in that the LEDs (63) sit on a printed circuit board (62), which conforms at least approximately to the contour of the additional reflector (7, 8).

7. Light, as claimed in claim 6,
characterized in that the light, emitted by the additional light source (18, 19, 20, 21, 26; 63) by way of the additional reflector (7, 8), is an indirect background lighting of the light (1).

8. Light, as claimed in claim 7,
characterized in that the additional reflector (7, 8) is a part of the light housing (6).

9. Light, as claimed in claim 8,
characterized in that that part of the light housing (6) that forms the additional reflector (7, 8) exhibits a reflecting coating (32) on the side of said light housing that faces the pane (10).

10. Light, as claimed in claim 5,
characterized in that the light guide (19, 20, 21, 26) for radiating light onto the additional reflector (7, 8) exhibits an output coupling optical system, which is adapted to the curvature of this reflector.

11. Light, as claimed in claim 9,
characterized in that the row of LEDs (63) and the light sources (69), assigned to the luminous fields (11, 12, 16, 22, 28, 29), are arranged jointly on the printed circuit board (62).

12. Light, as claimed in claim 11,
characterized in that the additional light sources (63), mounted on the printed circuit board in the rear-sided region of the light (1), are provided for the indirect background lighting of the light (1).

13. Light, as claimed in claim 12,
characterized in that the printed circuit board (62) is provided at a light source carrier (61), which can be inserted into the light housing (6) by way of an opening (33).

14. Light, as claimed in claim 13,
characterized in that the light source carrier (61) seals the opening (33) in the built-in position.

15. Light, as claimed in claim 14,
characterized in that the light source carrier (61) is a profile part.

16. Light, as claimed in claim 15,
characterized in that the light source carrier (61) exhibits at least one receptacle (68) for at least one printed circuit board (44).

17. Light, as claimed in claim 16,
characterized in that the receptacle (68) is constructed so as to be slotted.

18. Light, as claimed in claim 17,
characterized in that the light source carrier (61) is approximately U-shaped in its cross section.

19. Light, as claimed in claim 18,
characterized in that each leg (30, 31) of the light source carrier (61) exhibits at least one printed circuit board (62).

20. Light, as claimed in claim 19,
characterized in that the printed circuit boards (62) are provided on the outer sides of the legs (30, 31) of the light source carrier (61), said outer sides facing away from each other.

21. Light, as claimed in claim 20,
characterized in that at least one inner pane (40) is located between the reflectors (27, 41, 43, 45; 27, 43, 64, 66, 71) and the pane (10).

22. Light, as claimed in claim 21,
characterized in that the inner pane (40) is located opposite the outer pane (10) at a distance apart.

23. Light, as claimed in claim 22,
characterized in that the inner pane (40) is provided with retro-reflectors (23).

24. Light, as claimed in claim 23,
characterized in that the retro-reflector (23) is situated in the beam path (36) of the light beams, which are reflected at the additional reflector (7, 8) and which transilluminate the retro-reflector (23) from the backside.

25. Light, as claimed in claim 24,
characterized in that the reflectors (27, 41, 43, 45; 27, 43, 64, 76, 71) are transparent to the light beams (36), reflected by the additional reflector (7, 8).
